(19) United States
(12) Patent Application Publication
(10) Pub. No.: US 2010/0023597 A1
(43) Pub. Date: Jan. 28, 2010

(54) DISKLESS COMPUTER SYSTEM

(76) Inventor: Ching-Tung LU, Taoyuan (TW)

Correspondence Address: Hershkovitz & Associates, LLC, 2845 Duke Street, Alexandria, VA, 22314, US

(21) Appl. No.: 12/177,431

(22) Filed: Jul. 22, 2008

(51) Int. Cl. G06F 15/167; G06F 12/00

(52) U.S. Cl. 709/216; 711/112; 711/E12.001

(57) ABSTRACT

A diskless computer system has a network connecting device and a diskless computer connecting to the network connecting device. The diskless computer stores a disk driver and a network driver. The disk driver stores a device number corresponding to the network connecting device. The network driver is capable of obtaining the device number of the network connecting device. Therefore, the network connecting device either transfers disk packets or network packets to a network. Consequently, the network connecting device does not require complicated arbitration circuit in the conventional host bus adapter so the manufacture cost of the diskless computer system of the present invention is cheaper than the conventional diskless computer system.

### BACKGROUND OF THE INVENTION

1. Field of the Invention

The present invention relates to a diskless computer system, and more particularly to a diskless computer system that uses a single device number to access the Internet and disk partitions.

2. Description of Related Art

A diskless computer system is a computer system without installing disk drives locally. The diskless computer system comprises a diskless computer and a remote storage server having at least one disk drive. The diskless computer connects to the remote storage server over the Internet with a network storage protocol. When the diskless computer system boots, the diskless computer connects to the remote storage server to acquire data for finishing booting the diskless computer system. Therefore, the diskless computer does not require any physical disk drive, and the operating system, application programs and user data of the diskless computer are stored in the disk drive of the remote storage server. Consequently, the diskless computer system is popular with enterprises and educational circles because the security of data and the management of data in the diskless computer are better and easier.

With reference to FIG. 4, an host bus adapter (HBA) (71) has to be installed to a diskless computer (70) of a conventional diskless computer system to allow the diskless computer (70) to connect to a storage server (80) having at least one disk drive over a network (90). Furthermore, a network adapter (72) has to be installed to the diskless computer (70) to allow the diskless computer (70) to connect to the Internet over the network (90). To operate the HBA (71) and the network adapter (72), an HBA driver and a network adapter driver are installed to the diskless computer (70). The HBA driver registers a physical disk drive to the operating system executed by the diskless computer (70) with an HBA device number. The network adapter driver registers a network connecting device in the operating system with a network adapter device number. When a user operates the diskless computer (70) to transfer data to the storage server (80), the operating system of the diskless computer (70) transfers a writing data command to the HBA (71). The HBA (71) computes and transforms the writing data command to a writing data packet with a network storage protocol and transfers the writing data packet to the storage server (80). When the user operates the diskless computer (70) to transfer data to the Internet, the operating system of the diskless computer (70) transfers a network packet to the network adapter (72). The network adapter (72) transfers the network packet to the Internet over the network (90). To connecting the diskless computer (70) to the Internet and the storage server (80), the diskless computer (70) must have two device slots to install the HBA (71) and the network adapter (72) because the HBA (71) only provides a function for accessing the disk drive in the storage server (80) rather than connecting to the Internet. This causes waste of the spaces inside the diskless computer (70) and extra requirements to maintain the HBA (71) and the network adapter (72).

In order to allow the diskless computer (70) to connect to the Internet and the storage server (80) without separated HBA and network adapter, an improved HBA is invented. With reference to FIG. 5, the improved HBA (71′) comprises two core control chips (711, 712), a computer interface (713), a network interface unit (714) and an arbitration circuit (715). One of the core control chip (711) is in charge of processing disk commands, and the other core control chip (712) is in charge of processing packets. Furthermore, the diskless computer (70) installs a disk drier and a network driver corresponding respectively to the two core control chips (711, 712). The two drivers register respectively a physical disk drive and a network connecting device to the operating system. The two core control chips (711, 712) connect to the network interface unit (714) over the arbitration circuit (715). The network interface unit (714) comprises a network interface controller (714a) and a network port (714b), in the network port (714b) is used to connect to a network cable. Therefore, the diskless computer (70) is capable of connecting to the Internet and the storage server (80) by using the improved HBA (71′).

However, designing the arbitration circuit (715) is complicated, and complicated arbitration circuit (715) increases the manufacture cost of the improved HBA (71′).

To overcome the shortcomings, the present invention provides a diskless computer system that uses a single device number to access the Internet and disk partitions to mitigate or obviate the aforementioned problems.

### SUMMARY OF THE INVENTION

The main objective of the invention is to provide a diskless computer system that uses a single device number to access the Internet and disk partitions.

The diskless computer system that uses a single device number to access the Internet and disk partitions in accordance with the present invention comprises a network connecting device and a diskless computer connecting to the network connecting device. The diskless computer stores a disk driver and a network driver. The disk driver stores a device number corresponding to the network connecting device. The network driver is capable of obtaining the device number of the network connecting device. Therefore, the network connecting device either transfers disk packets or network packets to a network. Consequently, the network connecting device does not require complicated arbitration circuit in the conventional host bus adapter so the manufacture cost of the diskless computer system of the present invention is cheaper than the conventional diskless computer system.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a diskless computer system in accordance of the present invention;

FIG. 2 is a flow chart of a packet transmission process;

FIG. 3 is a flow chart of a packet receiving process;

FIG. 4 is a functional block diagram of a conventional diskless computer system; and

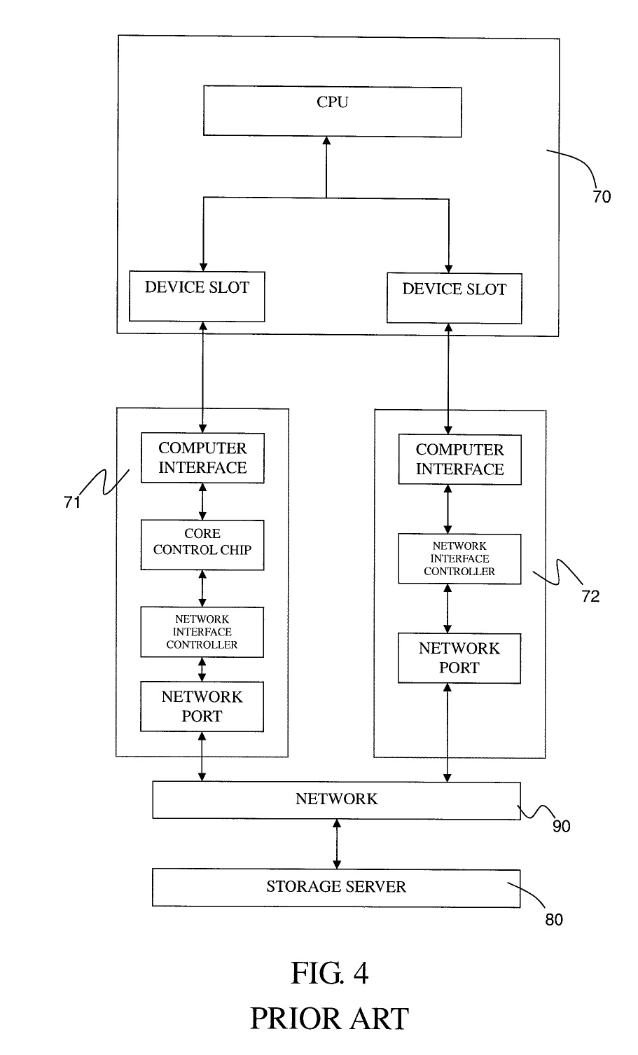

FIG. 5 is a functional block diagram of another conventional diskless computer system.

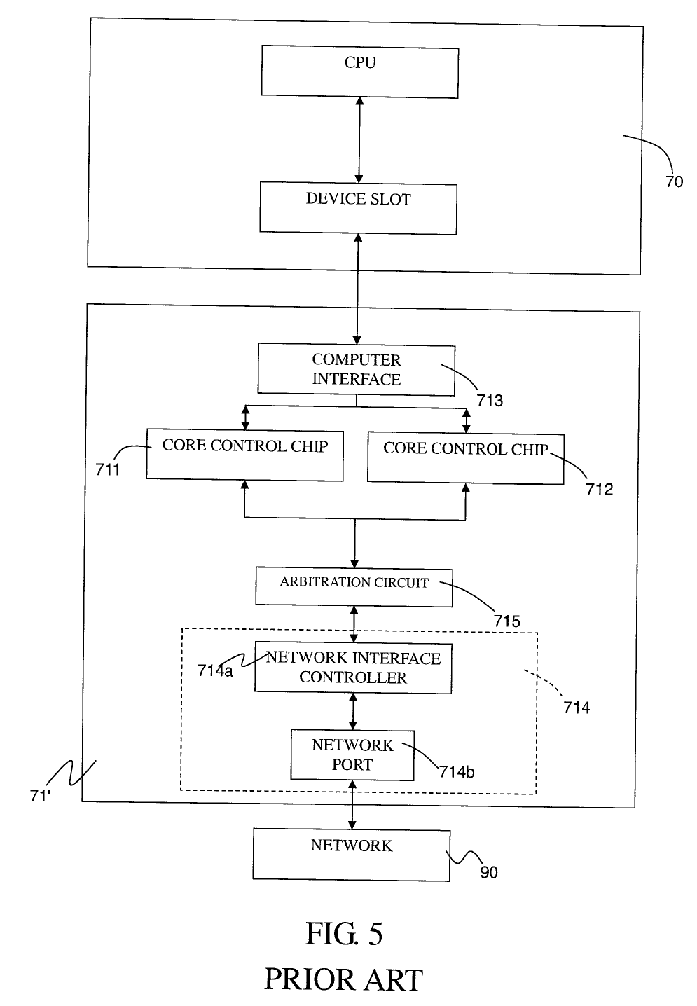

### DETAILED DESCRIPTION OF PREFERRED EMBODIMENT

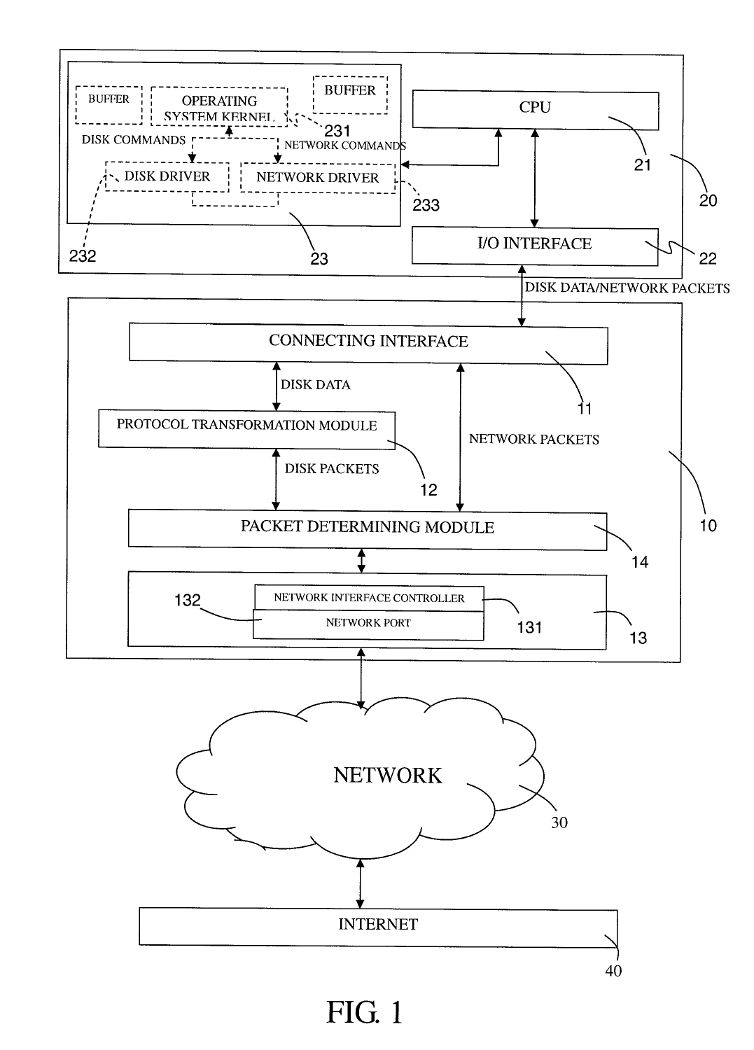

A diskless computer system in accordance with the present invention is applied to database of diskless computers, Web services, independent computing devices, mobile devices, servers, mainframes or the like. With reference to FIG. 1, the diskless computer system comprises a network connecting device (10) and a diskless computer (20).

The network connecting device (10) is capable of bidirectionally converting disk data between disk packets. The network connecting device (10) is further capable of connecting to a network (30) to receive network packets and the disk packets from the network (30) and alternatively transfer the network packets and the disk packets to the network (30).

The diskless computer (20) comprises a central processing unit (CPU) (21), an input and output (I/O) interface (22) and a storage medium (23).

The I/O interface (22) is connected to the CPU (21) and the network connecting device (10) and may be any kind of computer I/O interface, such as an universal serial bus (USB) interface, a peripheral component interconnect (PCI) interface, a IEEE 1394 interface or the like.

The storage medium (23) is connected to the CPU (21) and stores an operating system kernel (231), a disk driver (232) and a network driver (233).

The operating system kernel (231) is executed by the CPU (21) to issue disk commands and network commands and receive disk data and network data.

The disk driver (232) is executed by the CPU (21) and has a device number corresponding to the network connecting device (10). The device number may comprise a base address for writing data to and reading data from the storage medium (23) and a mapping address. The disk driver further (232) registers a physical disk drive to the operating system kernel (231) with the device number of the network connecting device (10). The disk driver (232) is capable of converting the data access commands from the operating system kernel (231) into disk data and transferring the disk data to the network connecting device (10) based on the device number of the network connecting device (10). Therefore, the network connecting device (10) converts the disk data into disk packets and transfers the disk packets to the network (30). The disk driver (232) also transfers the network data from the network connecting device (10) to the operating system kernel (231).

In addition, the disk driver (232) is capable of arranging a buffer in the storage medium (23) to temporarily store the disk commands from the operating system kernel (231). Therefore, the disk driver (232) can receive multiple data access commands and data access data to allow the CPU (21) to execute the disk driver (232) to process the data access commands and data access data in sequence. A preferred embodiment for doing so is that the disk driver (232) further has a hardware interrupt subprogram, and the disk driver (232) also registers a hardware interrupt service to the operating system kernel (231). When the network connecting device (10) transfers disk data reconverted from disk packets, the network connecting device (10) will also send an interrupt request. The operating system kernel (231) receives the interrupt request and calls the hardware interrupt subprogram of the disk driver (232). The disk driver (232) then transfers the disk data to the operating system kernel (231).

The network driver (233) is executed by the CPU (21) and is capable of converting network commands into network packets with a network protocol, such as Ethernet protocol. The network driver (233) is also capable of obtaining the device number of the network connecting device (10) and transferring the network packets to the network (30) over the network connecting device (10). Preferred embodiments for the network driver (233) obtaining the device number of the network connecting device (10) are as follows. If the operating system of the diskless computer (20) is Microsoft™ Windows, the network driver (233) will obtain the device number of the network connecting device (10) from the disk driver (232) during booting the diskless computer (20). On the other hand, if the operating system of the diskless computer (20) is Linux, the network driver (233) will obtain the device number of the network connecting device (10) from the operating system kernel (231) directly. Furthermore, the network driver (233) reconverts the network packets from the network connecting device (10) into network data and transfers the network data to the operating system kernel (231).

In addition, the network driver (233) is capable of arranging a buffer in the storage medium (23) to temporarily store the network packets to allow the CPU (21) to execute the network driver (233) to process the network packets in sequence. Preferred embodiments for the network driver (233) to deal with the network packets are as follows:

1. If the operating system of the diskless computer (20) is Microsoft™ Windows, the network driver (233) detects whether the buffer stores network packets with a polling method. When the network driver (233) detects that the buffer stores network packets, the network driver (233) reconverts the network packets from the network connecting device (10) into network data and transfers the network data to the operating system kernel (231).

2. If the operating system of the diskless computer (20) is Linux, the network driver (233) further has a hardware interrupt subprogram, and the network driver (233) also registers a hardware interrupt service to the operating system kernel (231). When the network connecting device (10) sends an interrupt request and the operating system kernel (231) receives it, the operating system kernel (231) then calls the hardware interrupt subprogram of the network driver (233) and transfers the network data to the operating system kernel (231).

The network connecting device (10) may be a host bus adapter and comprises a connecting interface (11), a protocol transformation module (12), a network interface unit (13) and a packet determining module (14).

The connecting interface (11) is for connecting to the I/O interface (22) of the diskless computer (20) to exchange the disk commands and the network packets with the diskless computer (20). The connecting interface (11) may be any kind of computer I/O interface, such as an USB interface, a PCI interface, a IEEE 1394 interface or the like.

The protocol transformation module (12) is connected to the connecting interface (22) and converts the disk commands into the disk packets based on a transmission protocol. The transmission protocol may be an Internet over small computer system interface (iSCSI) protocol or the like.

The network interface unit (13) is connected to the connecting interface (11) and the protocol transformation module (12). The network interface unit (13) connects the diskless computer (20) to the network (30) to allow the diskless computer (20) to exchange packets with the Internet (40). The network interface unit (13) may further comprise a network interface controller (131) and a network port (132), wherein the network port (132) is used to connect to a network cable.

The packet determining module (14) is connected to the network interface unit (13), the connecting interface (11) and the protocol transformation module (12). The packet determining module (14) transfers the network packets and the disk packets alternatively to the network (30) over the network interface unit (13). A preferred embodiment of transferring the network packets and the disk packets alternatively to the network (30) is to arranging the network packets and the disk packets respectively to a network packet queue and a disk packet queue. The packet determining module (14) transfers out the packets alternatively from the network packet queue and the disk packet queue. Furthermore, the packet determining module (14) determines whether received packets are converted based on the transmission protocol. If yes, the packets are the disk packets. The packet determining module (14) transfers the disk packets to the protocol transformation module (12) to reconvert the disk packets into disk data and transfer the disk data to the diskless computer (20) over the connecting interface (11). Otherwise, the packet determining module (14) transfers the network packets to the diskless computer (20) over the connecting interface (11) directly.

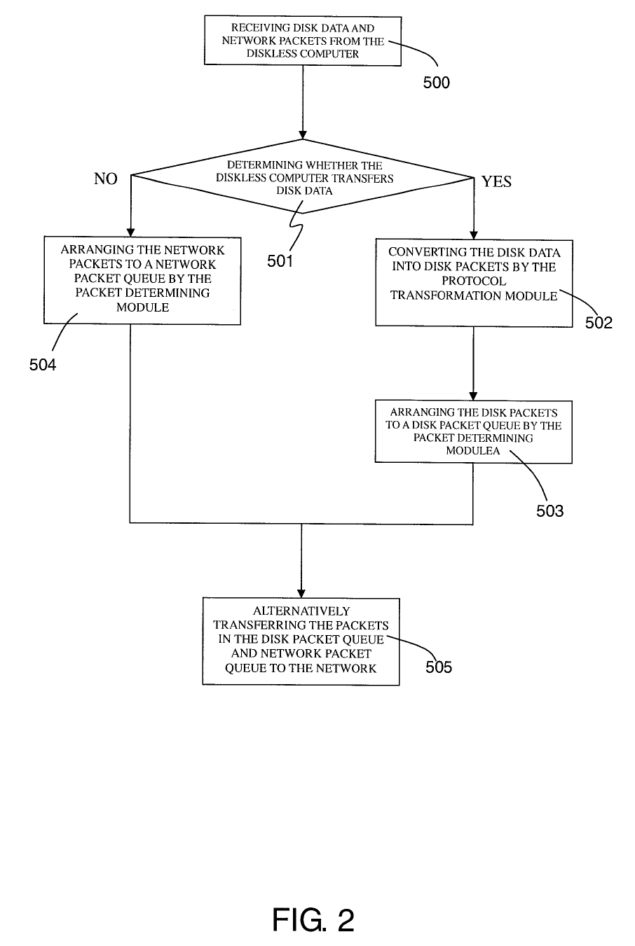

With further reference to FIG. 2, the network connecting device (10) further has a packet transmission process. The packet transmission process comprises acts of receiving disk data and network packets from the diskless computer (500), determining whether the diskless computer transfers disk data (501), converting the disk data into disk packets by the protocol transformation module (502) and arranging the disk packets to a disk packet queue by the packet determining module (503) when the diskless computer transfers disk data, arranging the network packets to a network packet queue by the packet determining module (504) when the diskless computer transfers network packets and alternatively transferring the packets in the disk packet queue and network packet queue to the network (505).

The act of alternatively transferring the packets in the disk packet queue and network packet queue to the network (505) may comprise the packet determining module (14) taking packets alternatively from the disk packet queue and the network packet queue with a round robin method and the network interface unit (13) transferring the taken packets to the Internet (40) over the network (30).

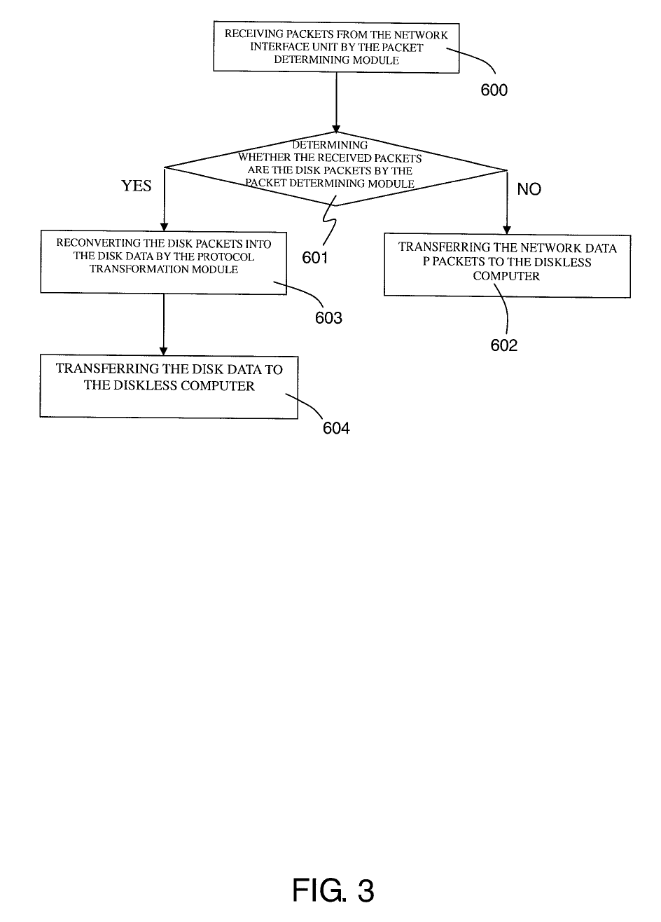

With further reference to FIG. 3, the network connecting device (10) further has a packet receiving process. The packet receiving process comprises acts of receiving packets from the network interface unit by the packet determining module (600), determining whether the received packets are the disk packets by the packet determining module (601), transferring the network data p packets to the diskless computer (602) when the received packets are the network packets and reconverting the disk packets into the disk data by the protocol transformation module (603) and transferring the disk data to the diskless computer (604) when the received packets are the disk packets.

The acts of transferring the network data p packets to the diskless computer (602) and transferring the disk data to the diskless computer (604) transfers data to the diskless computer (20) with a direct memory access (DMA) technique.

Based on the foregoing descriptions, the CPU (21) in the diskless computer (20) is capable of transferring data from the network driver (233) to the network connecting device (10) because the network driver (233) is capable of obtaining the device number of the network connecting device (10). Therefore, the network connecting device (10) either transfers the disk packets or the network packets to the network (30). Consequently, the network connecting device (10) does not require complicated arbitration circuit in the conventional host bus adapter so the manufacture cost of the diskless computer system of the present invention is cheaper than the conventional diskless computer system. Furthermore, the network connecting device (10) transfers the network packets and the disk packets alternatively so the operating system and application programs of the diskless computer (20) have stable operating efficiency.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A diskless computer system comprising:
a network connecting device being capable of bidirectionally converting disk data between disk packets and connecting to a network to receive network packets and the disk packets from the network and alternatively transfer the network packets and the disk packets to the network; and
a diskless computer comprising
a central processing unit (CPU);
an input and output (I/O) interface connected to the CPU and the network connecting device; and
a storage medium connected to the CPU and stores
an operating system kernel executed by the CPU to transfer disk commands and network commands and receive disk data and network data;
a disk driver executed by the CPU, having a device number corresponding to the network connecting device, registering a physical disk drive to the operating system kernel with the device number and being capable of converting the data commands from the operating system kernel into disk data and transferring the disk data to the network connecting device based on the device number of the network connecting device; and
a network driver executed by the CPU and being capable of converting the network commands into the network packets, obtaining the device number of the network connecting device, transferring the network packets to the network over the network connecting device, reconverting the network packets from the network connecting device into network data and transferring the network data to the operating system kernel.

2. The diskless computer system as claimed in claim 1, wherein the network connecting device further comprises:
a connecting interface connecting the I/O interface of the diskless computer to exchange the disk data and the network packets with the diskless computer;
a protocol transformation module connected to the connecting interface and bidirectionally converting the disk data into the disk packets based on a transmission protocol;
a network interface unit connected to the connecting interface and the protocol transformation module to allow the diskless computer to connect to the network; and
a packet determining module connected to the network interface unit, the connecting interface and the protocol transformation module, transferring the network packets and the disk packets alternatively to the network over the network interface unit, transferring the disk packets to the protocol transformation module to reconvert the disk packets into disk data and transfer the disk data to the diskless computer over the connecting interface and transferring the network packets to the diskless computer over the connecting interface directly.

3. The diskless computer system as claimed in claim 2, wherein the connecting interface and the I/O interface are peripheral component interconnect (PCI) interfaces.

4. The diskless computer system as claimed in claim 2, wherein the connecting interface and the I/O interface are universal serial bus (USB) interfaces.

5. The diskless computer system as claimed in claim 2, wherein the connecting interface of the network connecting device and the I/O interface of the diskless computer are IEEE 1394 interfaces.

6. The diskless computer system as claimed in claim 1, wherein:
the disk driver is further capable of arranging a buffer in the storage medium to temporarily store the disk commands from the operating system kernel to allow the CPU to execute the disk driver to process the data access commands and data access data in sequence; and
the network driver is further capable of arranging another buffer in the storage medium to temporarily store the network packets to allow the CPU to execute the network driver to process the network packets in sequence.

7. The diskless computer system as claimed in claim 6, wherein
the network driver detects whether the buffer stores network packets with a polling method; and
the network driver reconverts the network packets from the network connecting device into network data, and transfers the network data to the operating system kernel when the network driver detects that the buffer stores network packets.

8. The diskless computer system as claimed in claim 6, wherein:
the disk driver further has a hardware interrupt subprogram and registers a hardware interrupt service to the operating system kernel to allow the operating system kernel to call the hardware interrupt subprogram of the disk driver and the disk driver to transfer the disk data to the operating system kernel when the network connecting device sends an interrupt request to the operating system kernel; and
the network driver further has a hardware interrupt subprogram and registers a hardware interrupt service to the operating system kernel to allow the operating system kernel to call the hardware interrupt subprogram of the network driver and the network driver to transfer the network data to the operating system kernel when the network connecting device sends an interrupt request to the operating system kernel.

9. The diskless computer system as claimed in claim 2, wherein the transmission protocol is an Internet over small computer system interface (iSCSI) protocol.

10. The diskless computer system as claimed in claim 2, wherein the network driver is capable of converting network commands into network packets of the Ethernet protocol.

11. The diskless computer system as claimed in claim 2, wherein the network connecting device further has a packet transmission process comprising acts of:
receiving disk data and network packets from the diskless computer;
determining whether the diskless computer transfers disk data;
converting the disk data into disk packets by the protocol transformation module and arranging the disk packets to a disk packet queue by the packet determining module when the diskless computer transfers disk data;
arranging the network packets to a network packet queue by the packet determining module when the diskless computer transfers network packets; and
alternatively transferring the packets in the disk packet queue and network packet queue to the network.

12. The diskless computer system as claimed in claim 11, wherein the act of alternatively transferring the packets in the disk packet queue and network packet queue to the network comprises the packet determining module taking packets alternatively from the disk packet queue and the network packet queue with a round robin method and the network interface unit transferring the taken packets to the network.

13. The diskless computer system as claimed in claim 2, wherein the network connecting device further has a packet receiving process comprising acts of:
receiving packets from the network interface unit by the packet determining module;,
determining whether the received packets are the disk packets by the packet determining module;,
transferring the network packets to the diskless computer when the received packets are the network packets; and
reconverting the disk packets into the disk data by the protocol transformation module and transferring the disk data to the diskless computer when the received packets are the disk packets.

14. The diskless computer system as claimed in claim 13, wherein the network connecting device transfers data to the diskless computer with a direct memory access technique.
